(19) United States
(12) Patent Application Publication
(10) Pub. No.: US 2023/0325468 A1
(43) Pub. Date: Oct. 12, 2023

(54) MACHINE-LEARNING SYSTEM AND METHOD FOR PREDICTING EVENT TAGS

(71) Applicant: Accenture Global Solutions Limited, Dublin (IE)

(72) Inventors: Madhan Kumar Srinivasan, Bangaluru (IN); Kishore Kumar Gajula, Telangana (IN); Abdul Hammed Shaik, Telangana (IN); Ashish Pant, Bangalore (IN)

(21) Appl. No.: 17/729,097

(22) Filed: Apr. 26, 2022

Related U.S. Application Data
(60) Provisional application No. 63/328,346, filed on Apr. 7, 2022.

(51) Int. Cl. G06K 9/62; G06N 5/02

(52) U.S. Cl. CPC G06K 9/6259; G06N 5/022

(57) ABSTRACT

Methods, computer systems, and apparatus, including computer programs encoded on computer storage media, for training a machine-learning model for predicting event tags. The system obtains event data that specifies, for each of a plurality of events, a respective set of text fields characterizing the respective event. The system generates, from the event data, encoded language features for the plurality of events. The system also obtains knowledge data that specifies information of the event data. The system generates, from the event data and the knowledge data, tag data specifying a respective tag for each of the plurality of events. The system generates, from the tag data and the encoded language features, a respective encoded feature vector for each of the plurality of events. The system combines the tag data with the encoded feature vectors to generate a plurality of training examples.

### CROSS-REFERENCE TO RELATED APPLICATION

This application claims the benefit of U.S. Provisional Patent Application No. 63/328,346, filed Apr. 7, 2022, which is incorporated herein by reference.

### FIELD

This specification relates to machine-learning models to make predictions for events, such as predicting tags for information technology (IT) incidents.

### BACKGROUND

Machine-learning models that are used to make predictions for events typically have a plurality of parameters. The values of the machine-learning parameters can be determined using a training process based on training examples.

For example, a machine-learning model can be a neural network. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes computer-implemented systems and methods for predicting a tag for an event. For example, the event can be an IT incident. The predicted tag can specify a category of the IT incident.

In one particular aspect, the specification provides a training method for training a machine-learning model for predicting event tags. The training method can be performed by a system implemented as computer programs on one or more computers in one or more locations. The system obtains event data that specifies, for each of a plurality of events, a respective set of text fields characterizing the respective event. The system generates, from the event data, encoded language features for the plurality of events. The system also obtains knowledge data that specifies information of the event data. The system generates, from the event data and the knowledge data, tag data specifying a respective tag for each of the plurality of events. The system generates, from the tag data and the encoded language features, a respective encoded feature vector for each of the plurality of events. The system combines the tag data with the encoded feature vectors to generate a plurality of training examples. Each training example includes an encoded feature vector and a corresponding training tag. The system performs training of the machine-learning model on the plurality of training examples.

In some implementations of the training method, the respective tag for the respective event specifies an event category of the event. The plurality of events can include a plurality of information technology (IT) incidents, and the event data includes digital records of the IT incidents. The knowledge data can include data that specify a list of event categories, and one or more of keywords or indicators for one or more of the event categories. The knowledge data can be data obtained based on subject-matter expert (SME) knowledge.

In some implementations of the training method, the encoded language features include, for each of the plurality of events, n-gram features of the respective set of text fields characterizing the respective event. To generate the encoded language features for the plurality of events, the system can obtain one or more configuration parameters for an n-gram processing model, generate an n-gram input based on the event data, process the n-gram input using the n-gram processing model characterized by the specified configuration parameters to generate an n-gram output that includes a respective set of n-grams for each set of text fields characterizing the respective event, and process the n-gram output to generate the encoded language features. The configuration parameters can include one or more gram size parameters (e.g., a minimum gram size and a maximum gram size) and a feature size, and can be obtained by receiving a user input that specifies the parameters.

In some implementations of the training method, to process the n-gram output to generate the encoded language features, for each particular n-gram in each respective set of n-grams, the system can generate a corresponding embedded feature vector for the particular n-gram, and encodes the corresponding embedded feature vector into an encoded n-gram for the particular n-gram.

In some implementations of the training method, to generate the tag data, the system generates, from the event data and according to a selected n-gram feature configuration, a respective exhaustive list of n-grams for each of the plurality of events, and processes the exhaustive list of n-grams and the knowledge data to generate the tag data.

In some implementations of the training method, to perform training of the machine-learning model on the plurality of training examples, for each of the training examples, the system processes the encoded feature vector of the training example using the machine-learning model and in accordance with current values of parameters of the machine-learning model to generate a predicted tag for the encoded feature vector. The system determines a gradient with respect to the parameters of the machine-learning model of a training loss that measures, for each training example, an error between the predicted tag for the training example and the training tag in the training example, and updates the current values of the parameters using the gradient. The system can further generate, using the machine-learning model and in accordance with the current values of parameters of the machine-learning model, a plurality of predicted tags for a plurality of additional events, evaluate a prediction error for one or more of the predicted tags based on the knowledge data, determine, based on the prediction error, whether to perform an updated training of the machine-learning model, and in response to determining to perform the updated training, perform training of the machine-learning model on an updated set of training examples.

In another aspect, the specification provides a prediction method. The prediction method can be performed by a system implemented as computer programs on one or more computers in one or more locations. The system obtains event data that specifies, a set of text fields characterizing an event, generates a model input from the event data, generates an event tag for the event by processing the model input using a machine-learning model that has been trained using the training method described above, and outputs the predicted event tag.

In another aspect, the specification provides a system including one or more computers and one or more storage devices storing instructions that when executed by the one or more computers, cause the one or more computers to perform the above-described training method, the above-described prediction method, or both.

In another aspect, the specification provides one or more computer-readable storage media storing instructions that, when executed by one or more computers, cause the one or more computers to perform the operations of the above-described training method, the above-described prediction method, or both.

The subject matter described in this specification can be implemented in particular embodiments so as to realize one or more of the following advantages. The described techniques provide a method for training a machine-learning model that provides high-quality predictions of event tags (e.g., tags that specify respective categories of events, such as IT incidents). The training techniques enable generating training examples from unlabeled event data by leveraging SME knowledge to generate tag labels for the unlabeled event data. Since the unlabeled event data, such as unlabeled IT incident ticket data, can be widely available, the described techniques enable obtaining a large number of training examples for training a high-quality machine-learning model for predicting the event tag for a new event.

### BRIEF DESCRIPTION OF THE DRAWINGS

FIG. 1 shows an example system for generating an output tag for an event.

FIG. 2 shows an example training data generation system.

FIG. 3 shows an example model training system.

FIG. 4 is a flow diagram illustrating an example process for training a machine-learning model for predicting event tags.

Like reference numbers and designations in the various drawings indicate like elements.

### DETAILED DESCRIPTION

Analyzing data collected for an event to generate an event tag, i.e., an output that specifies feature information (e.g., category information) of the event, is an important aspect of managing events arising in various contexts. For example, when an information technology (IT) operations team receives an IT incident ticket, an important step leading to timely resolution of the underlying issue is to precisely identify the ticket category.

In this specification, an IT incident can refer to an unplanned interruption to an IT service, or a reduction in the quality of an IT service. Precise issue categorization of IT incidents not only brings in optimization opportunities, but also ensures the ticket triaging to the right teams with reduced hops for timely resolution, and enhances IT security. Precise issue categorization also identifies specific and potential problem areas for optimization thus enabling reduced effort for running the client service operations, and also improves client/end-user experience.

Machine-learning models are powerful tools for recognizing patterns in the input data for predicting an output, such as predicting an event tag containing classification information. As in the context of supervised learning, developing high-quality machine learning models for generating event tags may require a large amount of training data, e.g., a large number of training examples, for learning the model parameters of the machine learning models. A training example typically contains a training input to the machine-learning model and a corresponding ground-truth output label. For example, a training example used for training an event tag prediction machine-learning model can include an example of event data as the training input and a corresponding ground-truth event tag that specifies the correct features such as the precise category of the event. It can be extremely time-consuming and costly to compile a large number of training examples since the ground-truth output label in every training example needs to be generated or validated by an expert labeler.

This specification provides a solution for automatically identifying event tags, e.g., event tags without relying on a large number of training examples that have been manually labeled. In particular, the provided system trains a machine-learning model for predicting the event tags based on unlabeled event data and knowledge data that can be readily available, for example, from an expert knowledge database.

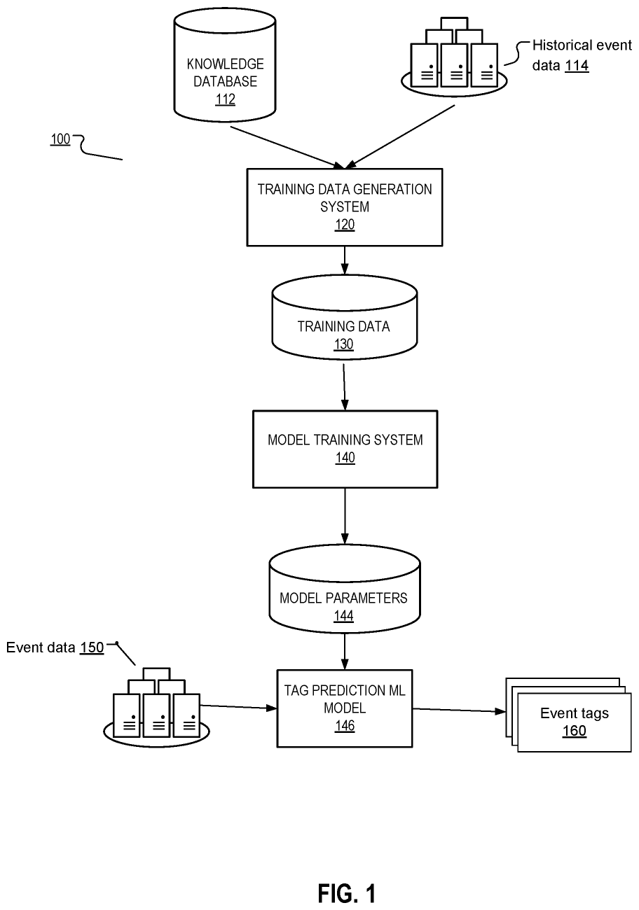

FIG. 1 is a diagram of an example system 100 for generating an output tag for an event. The system 100 includes a training data generation system 120 and a model training system 140.

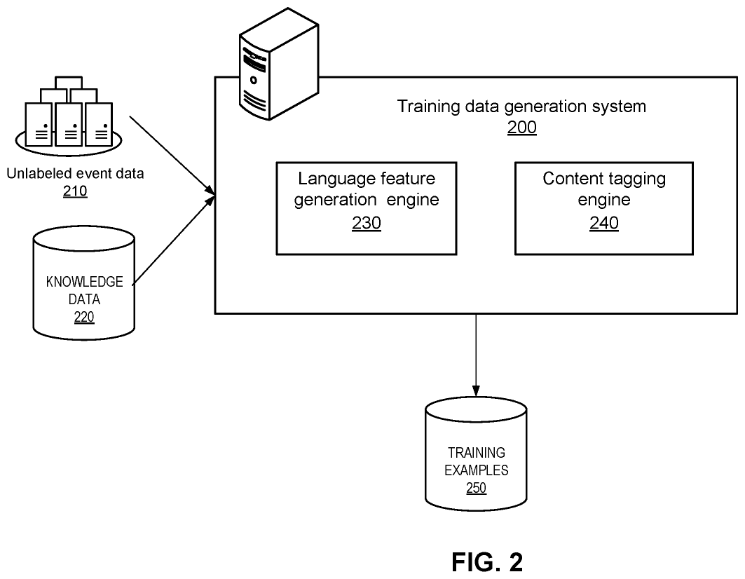

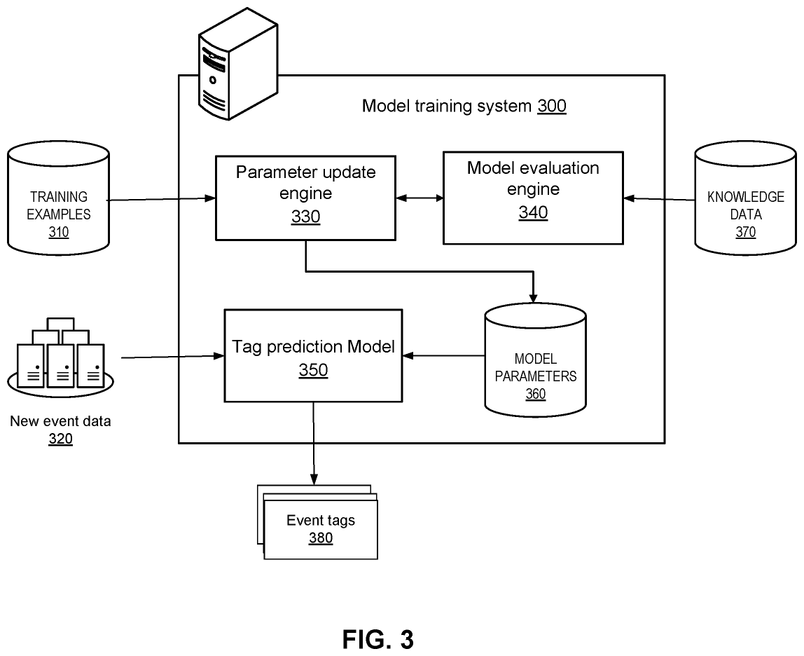

Implementation details and examples of the training data generation system 120 and the model training system 140 will be further described with references to FIG. 2 and FIG. 3. In general, the training data generation system 120 is configured to process historical event data 114 and data from a knowledge database 112 to generate training data 130. The model training system 140 is configured to use the training data 130 to perform training, i.e., to update the model parameters 144 of the machine learning model 146. After the machine-learning model 146 has been trained, the system 100 or another system can use the machine-learning model 146 to process event data 150 of an event to predict output event tag 160 for the event. The system 100 can present the output event tag 160 through a user interface or via data transmission.

FIG. 2 shows an example of a training data generation system 200. The system 200 is an example of a system implemented as computer programs on one or more computers in one or more locations, in which the systems, components, and techniques described below can be implemented. The system 200 is configured to generate training examples 250 that can be used to perform training of a machine-learning model configured to predict event tags from event data.

The system 200 receives unlabeled event data 210. In this specification, unlabeled event data generally refers to data describing one or more events where the tags (for example, event category tags) of the events are not available or are not used. In particular, the unlabeled event data 210 includes data that specifies, for each of a plurality of events, a respective set of text fields characterizing the respective event.

In some implementations, the plurality of events can be a plurality of information technology (IT) incidents, and the unlabeled event data 210 includes digital records (e.g., tickets) of the IT incidents. In one example, the text fields of an incident ticket can include fields such as “Incident Open Date”, “Incident Close Date”, “Priority”, “Status”, and “Ticket Description”.

The system 200 further receives knowledge data 220. The knowledge data 200 can be obtained from a database, e.g., an SME database, and can include data that specifies an exhaustive list of event categories and other expert information such as business-related keywords/indicators that fall under one or more event categories. The database SME can be maintained and/or updated based on the application requirements by the system 200 or a separate system.

The system 200 includes a language feature generation engine 230 and a content tagging engine 240. The language feature generation engine 230 generates, from the event data 210, encoded language features for the plurality of events. In particular, in some implementations, the encoded language features can include, for each of the plurality of events, n-gram features of the respective set of text fields characterizing the respective event.

In some implementations, to generate the encoded language features, the language feature generation engine 230 obtains one or more configuration parameters for an n-gram processing model. For example, the system 200 can receives a user input specifying the one or more configuration parameters via a user interface. The configuration parameters can include, for example, one or more gram size parameters, a feature size, or both. The gram size parameters can include a minimum gram size and a maximum gram size.

Based on the one or more configuration parameters of the n-gram processing model, the language feature generation engine 230 processes an n-gram input generated based on the event data, to generate an n-gram output that includes a respective set of n-grams for each set of text fields characterizing the respective event. The language feature generation engine 230 then processes the n-gram output with an encoding model to generate the encoded language features. The encoded language features can include, for each n-gram in the n-gram output, a numerical representation of the n-gram. The encoding model can be any appropriate n-gram encoder. For example, the encoding model can be a neural network with suitable architecture and network parameters. The language feature generation engine 230 can further generate, from at least encoded language features, a respective encoded feature vector for each of the plurality of events, e.g., by arranging the encoded language features into a vector format for each event based on a predefined feature configuration space.

The content tagging engine 240 generates, from the event data 210 and the knowledge data 220, tag data specifying a respective tag for each of the plurality of events. In some implementations, the content tagging engine 240 generates, from the event data and according to a selected n-gram feature configuration, a respective exhaustive list of n-grams for each of the plurality of events. The content tagging engine 240 then processes the exhaustive list of n-grams and the knowledge data to generate the tag data. In a particular implementation, the content tagging engine 240 performs pattern recognition and matching to transform the knowledge data 220 in the form of category-indicator associations into the tagging information. For example, for the event data for each event, the content tagging engine 240 generates a tag by pattern matching the keywords from the associations and the exhaustive list of n-grams.

After the tag data and the encoded feature vectors have been generated, the system 200 combines the tag data with the encoded feature vectors to generate a plurality of training examples 250. Each training example includes an encoded feature vector and a corresponding training tag. The training examples 250 will be used to train a machine-learning model for predicting event tags from event data.

An important feature of the system 200 is that it generates the training examples from unlabeled event data by leveraging knowledge data to generate tag labels for the unlabeled event data. Since the unlabeled event data, such as unlabeled IT incident ticket data, as well as the knowledge data, can be widely available, the system 200 enables obtaining a large number of training examples for training a high-quality machine-learning model for predicting the event tag for a new event.

FIG. 3 shows an example of a model training system 300. The system 300 is an example of a system implemented as computer programs on one or more computers in one or more locations, in which the systems, components, and techniques described below can be implemented. The system 300 performs training of a tag prediction model 350 that is configured to process new event data 320 to generate event tags 380 for the new event data 320. The tag prediction model 350 is a machine-learning model, such as a neural network with a suitable architecture. In one example, the prediction model 350 includes a neural network that has a deep convolutional neural network (CNN) architecture and adopts a SoftMax activation function. A categorical cross entropy loss function can be used for training the neural network. In another example, the prediction model 350 includes a decision tree, for example, a gradient boosted decision tree. In particular, a categorical boosting (CatBoost) framework can be used to implement and train the prediction model 350. By using the training process, the system 300 updates the model parameters 360, such as neural network weight and bias coefficients, of the tag prediction model 350.

The system 300 receives training examples 310 that have been generated by the training data generation system 200 described with reference to FIG. 2. A parameter update engine 330 of the model training system 300 uses the training examples to update the model parameters 360 of the tag prediction model 350. For example, when the tag prediction model 350 is a neural network, the parameter update engine 330 performs the parameter updates by a process including several steps. For each of the training examples, the parameter update engine 330 processes the encoded feature vector of the training example using the tag prediction model 350 and in accordance with current values of model parameters 360 to generate a predicted tag for the encoded feature vector. The parameter update engine 330 further determines a gradient with respect to the model parameters 360 of a training loss that measures, for each training example, an error between the predicted tag for the training example and the training tag in the training example. The parameter update engine 330 further updates the current values of the parameters using the gradient. The parameter updating process can be implemented by any appropriate techniques. For example, when the tag prediction model 350 includes a neural network, the parameter update engine 330 can use any backpropagation-based machine learning techniques, e.g., using the Adam or AdaGrad optimizers.

In some implementations, the model training system 300 further includes a model evaluation engine 340 that evaluates the performance, e.g., the prediction accuracy, of the tag prediction model 350 after the model has been trained. The system 300 can use the model evaluation engine 340 to monitor the performance of the tag prediction model 350 when the tag prediction model 350 is being used for predicting event tags, and update the model when the system determines it to be necessary. This can be useful when the characteristics and statistics of new event data evolve over time. In this case, the system 300 can keep track and maintain the prediction performance of the model even when the input data changes characteristics.

The model evaluation engine 340 generates, using the tag prediction model 350 and in accordance with the current values of parameters of the tag prediction model 350, a plurality of predicted tags for a plurality of additional events. The model evaluation engine 340 then evaluates a prediction error for one or more of the predicted tags based on the knowledge data 370. The model evaluation engine 340 can determine, based on the prediction error, whether to perform an updated training of the tag prediction model 350. For example, if the prediction error is above a predefined threshold, the model evaluation engine 340 can determine to perform the updated training, and in that case, performs training of the tag prediction model 350 on an updated set of training examples. The updated set of training examples can be obtained for example, from the system 200.

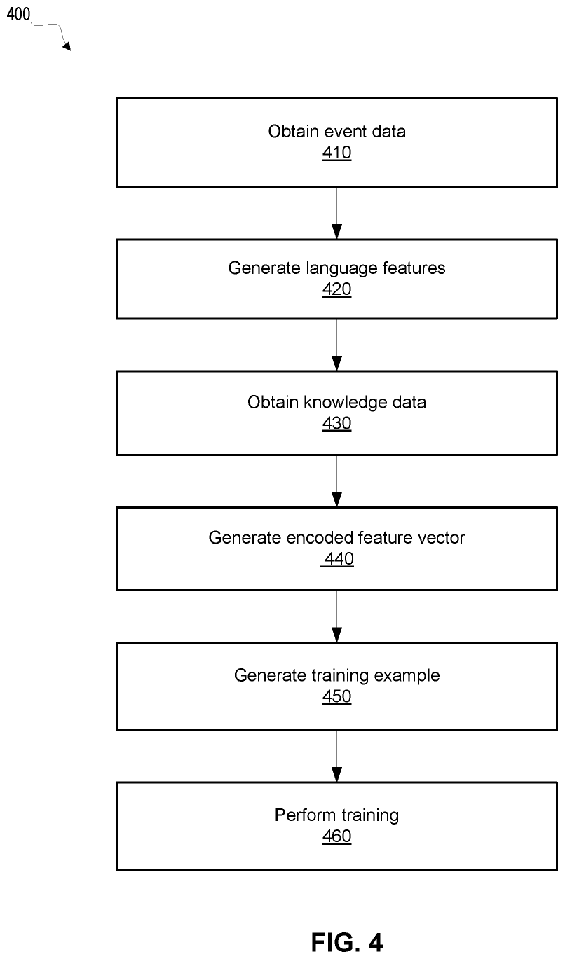

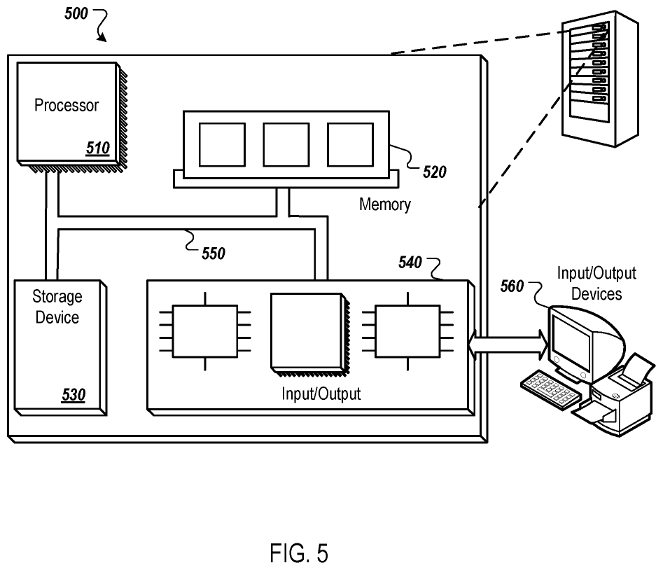

FIG. 4 is a flow diagram illustrating an example process 400 for training a machine-learning model for predicting event tags. For convenience, the process 400 will be described as being performed by a system of one or more computers located in one or more locations. For example, the system 100 described with reference to FIG. 1, appropriately programmed in accordance with this specification, can perform the process 400.

In step 410, the system 400 obtains event data that specifies, for each of a plurality of events, a respective set of text fields characterizing the respective event. In step 420, the system generates, from the event data, encoded language features for the plurality of events. In step 430, the system obtains knowledge data that specifies information of the event data. In step 440, the system generates, from the event data and the knowledge data, tag data specifying a respective tag for each of the plurality of events. In step 450, the system generates, from at least the encoded language features, a respective encoded feature vector for each of the plurality of events. In step 450, the system combines the tag data with the encoded feature vectors to generate a plurality of training examples. Each training example includes an encoded feature vector and a corresponding training tag label. In step 460, the system performs training of the machine-learning model on the plurality of training examples.

FIG. 5 shows an example computer system 500 that can be used to perform certain operations described above, for example, to perform the operations of the system 100 of FIG. 1, the system 200 in FIG. 2, or the system 300 in FIG. 3. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (for example, a cloud storage device), or some other large-capacity storage device.

The input/output device 540 provides input/output operations for the system 500. In one implementation, the input/output device 540 can include one or more network interface devices, for example, an Ethernet card, a serial communication device, for example, a RS-232 port, and/or a wireless interface device, for example, a 502.11 card. In another implementation, the input/output device can include driver devices configured to receive input data and send output data to other input/output devices, for example, keyboard, printer and display devices 560. Other implementations, however, can also be used, such as mobile computing devices, mobile communication devices, set-top box television client devices, etc.

Although an example system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by a data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, that is, one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, for example, an FPGA (field programmable gate array) or an ASIC (application-specific integrated circuit). The apparatus can optionally include, in addition to hardware, code that creates an execution environment for computer programs, for example, code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, for example, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device, for example, a universal serial bus (USB) flash drive, to name just a few.

Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of messages to a personal device, for example, a smartphone that is running a messaging application and receiving responsive messages from the user in return.

Data processing apparatus for implementing machine learning models can also include, for example, special-purpose hardware accelerator units for processing common and compute-intensive parts of machine learning training or production, that is, inference, workloads.

Machine learning models can be implemented and deployed using a machine learning framework, for example, a TensorFlow framework, a Microsoft Cognitive Toolkit framework, an Apache Singa framework, or an Apache MXNet framework.

Embodiments of the subject matter described in this specification can be implemented in a computing system that includes a back-end component, for example, as a data server, or that includes a middleware component, for example, an application server, or that includes a front-end component, for example, a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, for example, an HTML page, to a user device, for example, for purposes of displaying data to and receiving user input from a user interacting with the device, which acts as a client. Data generated at the user device, for example, a result of the user interaction, can be received at the server from the device.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented training method for training a machine-learning model for predicting event tags from event data, comprising:
obtaining event data that specifies, for each of a plurality of events, a respective set of text fields characterizing the respective event;
generating, from the event data, encoded language features for the plurality of events;
obtaining knowledge data that specifies information of the event data;
generating, from the event data and the knowledge data, tag data specifying a respective tag for each of the plurality of events;
generating, from at least the encoded language features, a respective encoded feature vector for each of the plurality of events;
combining the tag data with the encoded feature vectors to generate a plurality of training examples, each training example including an encoded feature vector and a corresponding training tag; and
performing training of the machine-learning model on the plurality of training examples.

2. The method of claim 1, wherein the respective tag for the respective event specifies an event category of the event.

3. The method of claim 1, wherein the plurality of events include a plurality of information technology (IT) incidents, and the event data includes digital records of the IT incidents.

4. The method of claim 1, wherein the knowledge data include data that specify a list of event categories, and one or more of keywords or indicators for one or more of the event categories.

5. The method of claim 1, wherein the encoded language features include, for each of the plurality of event, n-gram features of the respective set of text fields characterizing the respective event.

6. The method of claim 5, wherein generating the encoded language features for the plurality of events comprises:
obtaining one or more configuration parameters for an n-gram processing model;
generating an n-gram input based on the event data;
processing the n-gram input using the n-gram processing model characterized by the specified configuration parameters to generate an n-gram output that includes a respective set of n-grams for each set of text fields characterizing the respective event; and
processing the n-gram output to generate the encoded language features.

7. The method of claim 6, wherein obtaining the one or more configuration parameters for the n-gram processing model comprises:
receiving a user input specifying the one or more configuration parameters.

8. The method of 6, wherein the configuration parameters include one or more gram size parameters and a feature size.

9. The method of claim 8, wherein the gram size parameters include a minimum gram size and a maximum gram size.

10. The method of claim 1, wherein generating the tag data comprises:
generating, from the event data and according to a selected n-gram feature configuration, a respective exhaustive list of n-grams for each of the plurality of events; and
processing the exhaustive list of n-grams and the knowledge data to generate the tag data.

11. The method of claim 1, wherein performing training of the machine-learning model on the plurality of training examples comprises:
for each of the training examples, processing the encoded feature vector of the training example using the machine-learning model and in accordance with current values of parameters of the machine-learning model to generate a predicted tag for the encoded feature vector;
determining a gradient with respect to the parameters of the machine-learning model of a training loss that measures, for each training example, an error between the predicted tag for the training example and the training tag in the training example; and
updating the current values of the parameters using the gradient.

12. The method of claim 11, wherein performing training of the machine-learning model further comprises:
generating, using the machine-learning model and in accordance with the current values of parameters of the machine-learning model, a plurality of predicted tags for a plurality of additional events;
evaluating a prediction error for one or more of the predicted tags based on the knowledge data;
determining, based on the prediction error, whether to perform an updated training of the machine-learning model; and
in response to determining to perform the updated training, performing training of the machine-learning model on an updated set of training examples.

13. A computer-implemented prediction method, comprising:
obtaining event data that specifies, a set of text fields characterizing an event;
generating a model input from the event data;
generating an event tag for the event by processing the model input using a machine-learning model that has been trained using the training method of claim 1; and
outputting the predicted event tag.

14. The method of claim 13, wherein the event tag specifies an event category of the event.

15. The method of claim 13, wherein the event is an information technology (IT) incident, and the event data includes a digital record of the IT incident.

16. The method of claim 13, wherein the machine-learning model includes a neural network or a decision tree.

17. A system comprising one or more computers and one or more storage devices storing instructions that when executed by the one or more computers, cause the one or more computers to perform:
obtaining event data that specifies, for each of a plurality of events, a respective set of text fields characterizing the respective event;
generating, from the event data, encoded language features for the plurality of events;
obtaining knowledge data that specifies information of the event data;
generating, from the event data and the knowledge data, tag data specifying a respective tag for each of the plurality of events;
generating, from at least the encoded language features, a respective encoded feature vector for each of the plurality of events;
combining the tag data with the encoded feature vectors to generate a plurality of training examples, each training example including an encoded feature vector and a corresponding training tag; and
performing training of the machine-learning model on the plurality of training examples.

18. The system of claim 17, wherein the event is an information technology (IT) incident, and the event data includes a digital record of the IT incident.

19. One or more computer-readable storage media storing instructions that, when executed by one or more computers, cause the one or more computers to perform:
obtaining event data that specifies, for each of a plurality of events, a respective set of text fields characterizing the respective event;
generating, from the event data, encoded language features for the plurality of events;
obtaining knowledge data that specifies information of the event data;
generating, from the event data and the knowledge data, tag data specifying a respective tag for each of the plurality of events;
generating, from at least the encoded language features, a respective encoded feature vector for each of the plurality of events;
combining the tag data with the encoded feature vectors to generate a plurality of training examples, each training example including an encoded feature vector and a corresponding training tag; and
performing training of the machine-learning model on the plurality of training examples.

20. The computer-readable storage media of claim 19, wherein the event tag specifies an event category of the event.
